(19) United States
(12) Patent Application Publication
(10) Pub. No.: US 2010/0131612 A1
(43) Pub. Date: May 27, 2010

(54) METHOD FOR TRANSMITTING VIDEO DATA

(75) Inventor: Chia-Wei TU, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: INVENTEC CORPORATION, Taipei (TW)

(21) Appl. No.: 12/626,722

(22) Filed: Nov. 27, 2009

(30) Foreign Application Priority Data
Nov. 27, 2008 (TW) 97145957

(51) Int. Cl. G06F 15/16

(52) U.S. Cl. 709/217; 709/246

(57) ABSTRACT

A method for transmitting video data includes the following steps. A first portable electronic device is activated, and a video image is captured and displayed on a second portable electronic device. The second portable electronic device determines whether to enable a data synchronization function to transmit a to-be-transmitted file. If the data synchronization function is enabled, the second portable electronic device determines and transforms the format of the to-be-transmitted file. The second portable electronic device transmits the transformed to-be-transmitted file to the first portable electronic device to display the transformed to-be-transmitted file on the first portable electronic device.

This application claims the benefit of Taiwan application Serial No. 97145957, filed Nov. 27, 2008, the subject matter of which is incorporated herein by reference.

### BACKGROUND OF THE INVENTION

1. Field of the Invention

The invention relates in general to a method for transmitting video data, and more particularly to a method for transmitting video data capable of simultaneously displaying the file with a videophone.

2. Description of the Related Art

With the arrival of the age of 3G audio/video cellular phone, a videophone which is one of the basic functions of 3G cellular phone has become very popular. The videophone enables the user to hear the voice and view the facial expression of the other call party. However, if the user would like to let the other call party view an file of image format or a file of text data format, the supporting functions of the videophone of 3G cellular phone still cannot simultaneously display the other call party's image and file of image format or text data format, and this is very inconvenient in use.

### SUMMARY OF THE INVENTION

The invention is directed to a method for transmitting video data. A data synchronization function is enabled and the format of the to-be-transmitted file is converted to a format which can be displayed on a videophone, so that the caller and the callee can directly discuss the content of the to-be-transmitted file via the data synchronization function and the call function.

According to a first aspect of the present invention, a method for transmitting video data is provided. The method includes the following steps. A first portable electronic device is activated, and a video image is captured and displayed on a second portable electronic device. Whether to enable a data synchronization function to transmit a to-be-transmitted file is determined by the second portable electronic device. The format of the to-be-transmitted file is determined and transformed by the second portable electronic device if the data synchronization function is enabled. The transformed to-be-transmitted file to the first portable electronic device is transmitted by the second portable electronic device to display the transformed to-be-transmitted file on the first portable electronic device.

According to a second aspect of the present invention, a method for transmitting video data is provided. The method includes the following steps.

A first portable electronic device is activated, and a video image is captured and displayed on a second portable electronic device. Whether to enable a data synchronization function to receive a to-be-transmitted file is determined by the second portable electronic device. The video image is closed by the second portable electronic device if the data synchronization function is enabled. The to-be-transmitted file is received and displayed on the second portable electronic device.

The invention will become apparent from the following detailed description of the preferred but non-limiting embodiments. The following description is made with reference to the accompanying drawings.

### BRIEF DESCRIPTION OF THE DRAWINGS

FIG. 1 shows an example of a flowchart of a method for transmitting video data according to a preferred embodiment of the invention; and

FIG. 2 shows another example of a flowchart of a method for transmitting video data according to a preferred embodiment of the invention.

### DETAILED DESCRIPTION OF THE INVENTION

The invention provides a method for transmitting video data. A data synchronization function is enabled and the format of the to-be-transmitted file is converted to be displayed on a videophone, so that the caller and the callee can discuss the content of the to-be-transmitted file via the data synchronization function and the call function.

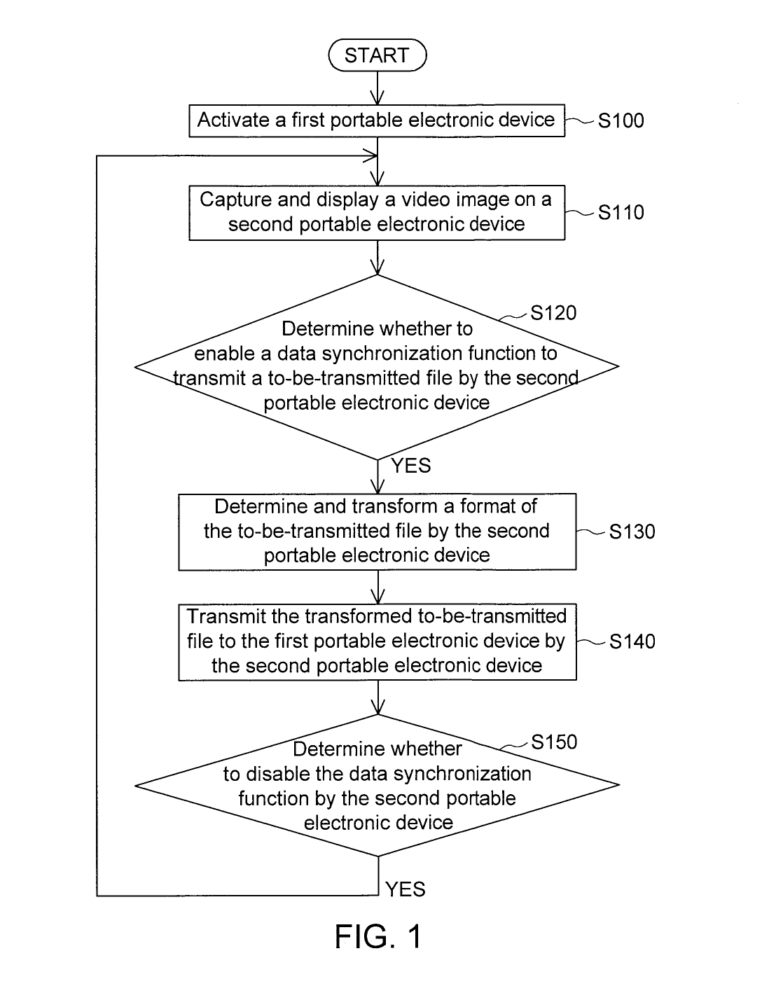

Referring to FIG. 1, an example of a flowchart of a method for transmitting video data according to a preferred embodiment of the invention is shown. The first portable electronic device and the second portable electronic device are a cellular phone for example, or a 3G cellular phone in particular, but the invention is not limited thereto. Firstly, the method begins at step S100, a first portable electronic device is activated. Next, the method proceeds to step S110, a video image is captured by the first portable electronic device and transmitted and displayed on the screen of a second portable electronic device. Step S100 and step S110 are substantially for connecting the first portable electronic device and the second portable electronic device to communicate as a videophone.

Then, the method proceeds to step S120, whether to enable a data synchronization function to transmit a to-be-transmitted file is determined by the second portable electronic device. If the data synchronization function is enabled, then the method proceeds to step S130, the format of the to-be-transmitted file is determined and transformed by the second portable electronic device. For example, if the format of the to-be-transmitted file is a text data format, then the format of the to-be-transmitted file is converted to a picture format from the text data format, and if the format of the to-be-transmitted file is an image format, then the format of the to-be-transmitted file is converted to a videophone format from the image format. That is, as long as the format of the to-be-transmitted file is converted to a format that can be displayed on the videophone would do, and no further restriction is applied.

Afterwards, the method proceeds to step S140, the transformed to-be-transmitted file is transmitted to the first portable electronic device by the second portable electronic device so that the transformed to-be-transmitted file is displayed on the screen of the first portable electronic device. After the transformed to-be-transmitted file is transmitted to the first portable electronic device, then the method proceeds to step S150, whether to disable the data synchronization function is determined by the second portable electronic device. If the second portable electronic device disables the data synchronization function, then the first portable electronic device and the second portable electronic device are connected and the videophone state is resumed.

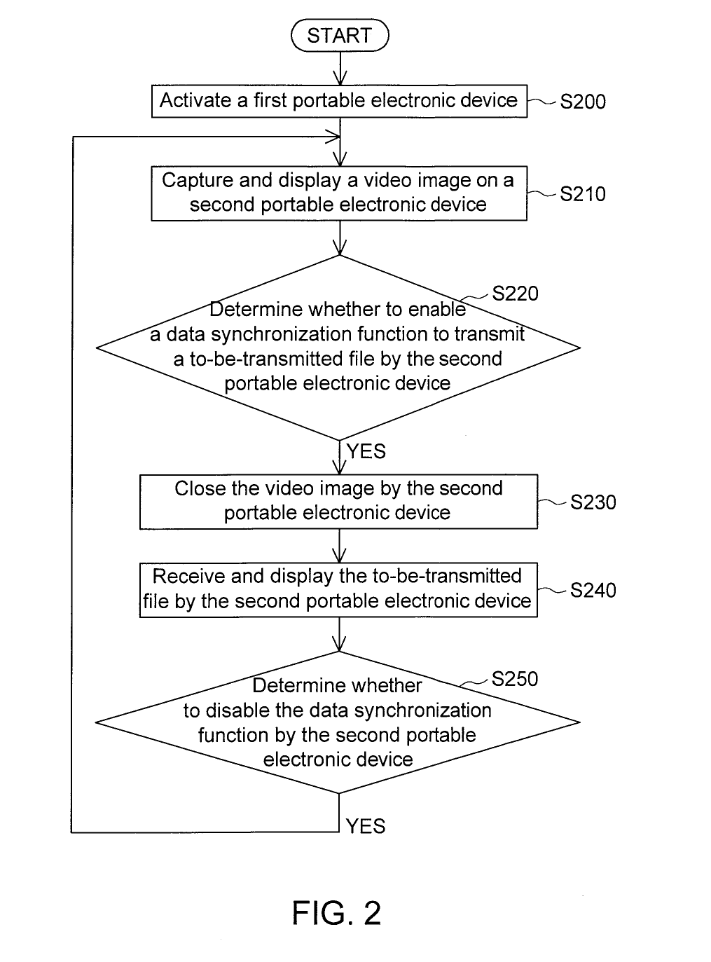

Referring to FIG. 2, another example of a flowchart of a method for transmitting video data according to a preferred embodiment of the invention is shown. The first portable electronic device and the second portable electronic device are a cellular phone or a 3G cellular phone in particular, but the invention is not limited thereto. The method begins at step S200, a first portable electronic device is activated. Next, the method proceeds to step S210, a video image is captured by the first portable electronic device and is transmitted and displayed on the screen of a second portable electronic device. Step S200 and step S210 substantially for connecting the first portable electronic device and the second portable electronic device to communicate as a videophone.

Then, the method proceeds to step S220, whether to enable a data synchronization function to receive a to-be-transmitted file is determined by the second portable electronic device. If the data synchronization function is enabled, then the method proceeds to step S230, the video image is closed by the second portable electronic device. Afterwards, the method proceeds to step S240, the to-be-transmitted file is received and displayed on the second portable electronic device. The to-be-transmitted file and the video image are displayed on the same window of the screen of the second portable electronic device, but the invention is not limited thereto.

Then, the method proceeds to step S240, the to-be-transmitted file and the video image can also be displayed on different windows of the screen of the second portable electronic device, or the to-be-transmitted file can be displayed in a full screen on the second portable electronic device screen. After the to-be-transmitted file is received, the method proceeds to step S250, whether to disable the data synchronization function is determined by the second portable electronic device. If the second portable electronic device disables the data synchronization function, then the first portable electronic device and the second portable electronic device are connected and the videophone state is resumed.

Let the second portable electronic device have a global positioning system (GPS), but the first portable electronic device does not have a GPS.

If the user of the first portable electronic device would like to go to a destination but does not know the route, then the user of the second portable electronic device, who is communicating as a videophone with the user of the first portable electronic device, can enable a data synchronization function and converts relevant GPS map to a picture format to be transmitted to and displayed on the screen of the first portable electronic device.

Meanwhile, the user of the first portable electronic device also enables a data synchronization function to receive and display the converted GPS map on the screen of the first portable electronic device. If the converted GPS map and the video image are displayed on the same window, then the video image must be closed first. If the user finds that the GPS map displayed on the window is not clear, the user may choose to display the GPS map in a full screen on the screen of the first portable electronic device. Thus, the user of the second portable electronic device, via the data synchronization function and the call function, can discuss with the user of the first portable electronic device about how to get to the destination by following the GPS map.

Let the first portable electronic device and the second portable electronic device have an identical application program. If the user of the first portable electronic device does not know how to use the application program, then the user of the second portable electronic device, who is communicating as a videophone with the user of the first portable electronic device, can enable a data synchronization function and convert the image file of the operating procedures of the application program to a format applicable to the videophone, so that the converted image file is transmitted and displayed on the screen of the first portable electronic device.

Meanwhile, the user of the first portable electronic device also enables a data synchronization function to receive and display the converted image file on the screen of the first portable electronic device. Thus, the user of the second portable electronic device, via the data synchronization function and the call function, can directly teach the user of the first portable electronic device how to use the application program.

According to the method for transmitting video data of the above embodiments of the invention, when the first portable electronic device and the second portable electronic device are connected for communicating as a videophone, a data synchronization function is enabled for converting the to-be-transmitted file to a format which can be displayed on the videophone, so that the caller and the callee the user can directly discuss about the content of the to-be-transmitted file via the data synchronization function and the call function, largely increasing the convenience of use.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for transmitting video data, comprising:
activating a first portable electronic device for capturing and displaying a video image on a second portable electronic device;
determining whether to enable a data synchronization function to transmit a to-be-transmitted file by the second portable electronic device;
determining and transforming a format of the to-be-transmitted file by the second portable electronic device if the data synchronization function is enabled; and
transmitting the transformed to-be-transmitted file to the first portable electronic device by the second portable electronic device to display the transformed to-be-transmitted file on the first portable electronic device.

2. The method for transmitting video data according to claim 1, wherein the format of the to-be-transmitted file is converted to a picture format from a text data format.

3. The method for transmitting video data according to claim 1, wherein the format of the to-be-transmitted file is converted to a videophone format from an image format.

4. The method for transmitting video data according to claim 1, wherein the to-be-transmitted file is a global positioning system (GPS) map.

5. The method for transmitting video data according to claim 1, wherein after the transformed to-be-transmitted file is transmitted to the first portable electronic device, the second portable electronic device further determines whether to disable the data synchronization function.

6. A method for transmitting video data, comprising:
activating a first portable electronic device for capturing and displaying a video image on a second portable electronic device;
determining whether to enable a data synchronization function to receive a to-be-transmitted file by the second portable electronic device;
closing the video image by the second portable electronic device if the data synchronization function is enabled; and
receiving and displaying the to-be-transmitted file by the second portable electronic device.

7. The method for transmitting video data according to claim 6, wherein the to-be-transmitted file and the video image are displayed on the same window on the screen of the second portable electronic device.

8. The method for transmitting video data according to claim 6, wherein the to-be-transmitted file and the video image are displayed on different windows on the screen of the second portable electronic device.

9. The method for transmitting video data according to claim 6, wherein the to-be-transmitted file is displayed in a full screen on the screen of the second portable electronic device.

10. The method for transmitting video data according to claim 6, wherein after the to-be-transmitted file is received, the second portable electronic device further determines whether to disable the data synchronization function.
